(19) United States
(12) Patent Application Publication
(10) Pub. No.: US 2012/0325370 A1
(43) Pub. Date: Dec. 27, 2012

(54) METHOD FOR PRODUCING AND PROCESSING WOOD CHIPS

(76) Inventors: Lisbeth Hellström, Sundsvall (SE); Per Engstrand, Liden (SE); Torbjörn Carlberg, Sundsvall (SE); Per Gradin, Stode (SE); Oyvind Gregersen, Trondheim (NO)

(21) Appl. No.: 13/581,898

(22) PCT Filed: Mar. 2, 2011
(86) PCT No.: PCT/SE2011/000042

§ 371 Date: Aug. 30, 2012

(30) Foreign Application Priority Data
Mar. 5, 2010 (SE) 1000210-3

(51) Int. Cl. B27L 11/02; B27M 1/08

(52) U.S. Cl. 144/360; 144/373; 144/364

(57) ABSTRACT

This patent application describes a method to produce wood chips with the intention of reducing the energy consumption in the subsequent process steps for pulp production. With the present method wood chipping is done in a wood chipper where the chipping tool (3) has an angle γ (4) within the interval of 75° to 105° between the fibre direction of the log and the side of the tool which faces the chip (2). Angles in this interval will cause an axially directed compression of the chip which will cause a cracking of the wood during chipping.

### FIELD OF THE INVENTION

The present invention concerns a method for the production and processing of wood chips for pulp and paper production in accordance with the claims.

### BACKGROUND OF THE INVENTION AND PRIOR ART

Methods for producing wood chips for pulp production or alternatively bio-energy are previously known. Chipping is normally done by some type of wood chipper such as a disc or drum chipper. Common for these chippers are that they contain a number of chipping tools that cut the wood into chips. The chipping tools consist normally of knives or the like. The characteristics and properties of the chips are affected by the geometry of the chipping tools, but also by the cutting angle in relation to the fibre's direction in the wood.

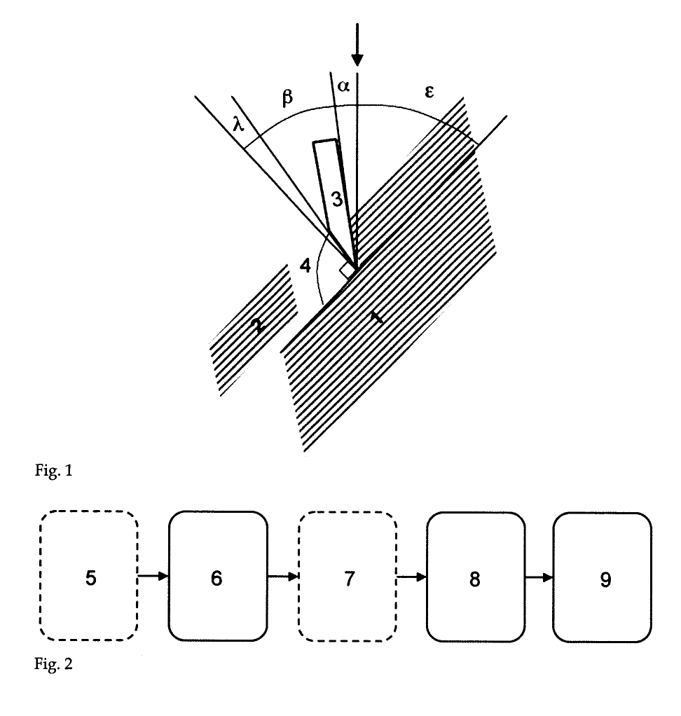

The angles that affect the chipping process and the chip properties are shown in FIG. 1 where 1 is the log, 2 is the chip and the black lines define the fibre direction. The three angles α, β and ε are the clearance angle, the edge angle and the spout angle respectively. The spout angle (ε) is the angle between the fibre orientation and the cutting direction (shown by an arrow in FIG. 1). The clearance angle (α) is according to present technology typically 3°. The clearance angle affects the feeding speed of the log towards the chipping disc. The edge angle (β) quantifies the wedge shape of the chipping tool 3, knife or similar. The angle λ in FIG. 1 is a complementary angle defined as: λ=90°−(α+β+ε). The angle 4 that primarily affects the load on the chips is given in FIG. 1 as γ and is defined as: γ=λ+90°.

The properties the chips receive during chipping affect the subsequent unit processes. As an example in production of sulphate (kraft) or sulphite pulp it has traditionally been seen as a benefit for the subsequent processes that the chips have as little compression damage as possible. Chipping for pulp production is therefore done using a technology to minimize such compression damage.

Compression damage is caused by the compressive stresses acting on the edge of the chip that is in contact with the chipping tool (knife) during chipping. The shape and cutting angles of the chipping tool (knife) will result in such compression damage to different extents. It has been shown that the compression damage in the chips is minimized at a spout angle (ε) approaching 30°. A spout angle close to 30° is therefore used during the chipping process according to the present state of the art. This angle has been seen as the most beneficial for the fibre properties for chemical pulps.

Two major problems for production of pulp and paper is high energy consumption and high investment costs in process equipment. The energy consumption of the wood chipping process is a minor (insignificant) part of the total energy consumption. For production of mechanical pulp such as thermomechanical pulp (TMP) and chemithermomechanical pulp (CTMP) the energy consumption is high, often in the range 1000-3000 kWh/t. The most energy demanding process equipments are the refiners in which the defibration of chips into pulp fibres and further fibrillation and development of these fibres are performed. These refiners consumes up to 90% of the electrical energy used in the pulp production. The current high price of energy and the ongoing concerns about greenhouse gases motivates reductions in the energy consumption during pulp production. More specifically there exists a need to reduce energy consumption during the extremely energy consuming process of turning chips into pulp. In addition there is a need to increase the production capacity during production of both mechanical and chemical pulps without new capital investments.

A number of methods to reduce the consumption of electrical energy in the refining stage have been developed in the past. For example several pre-treatment stages for chips before refining have been developed. Trials have shown that pre-treatment of chips has the potential of reducing the specific energy consumption [kWh/t] in the subsequent refining stages.

A number of different equipment types have been developed to compress wood chips after chipping in order to reduce energy consumption during refining. For example the chips may be subjected to compression in a compression screw (plug screw). The drawbacks of compression screws are that they increase the capital cost of the plant and the complexity of the process. The present method is also principally different in the respect that in a screw the chips are compressed in a random direction whereas in the present method the compression is oriented in the fibre direction. The energy consumption for compression screw pre-treatment of chips is in the range of 20-40 kWh/t.

The company Andritz has developed an equipment which is marketed as RT Pressafiner. Using the RT Pressafiner the chips are compressed by the action of an advanced compression screw. The RT Pressafiner has the disadvantages of adding to the process complexity. Further the chips are not only compressed in the fibre direction. This equipment also requires a lot of space and may thus be difficult to install in an existing process.

Further it is known that energy consumption may be reduced by compressing chips in roll nip (between at least two rolls). The design essentially hinders the chips from being compressed in the direction of the fibres resulting in the compression of the chips at a right angle in relation to the fibre direction. This method is therefore significantly different from the method described in the present patent application.

It has also been shown that energy consumption during refining of chips may be decreased by a chemical pre-treatment of the chips between chipping and refining. One such method is described in an article by Hill, Sabourin, Aichinger and Johansson as presented at IMPC Sundsvall 2009.

It has unexpectedly been shown that it is possible to achieve a large reduction in electrical energy consumption during chip refining without introducing new process stages. This can be accomplished by applying different load angles 4 according to what is described in the present method. The method according to the present invention goes against the established knowledge in the field which declares that minimizing the compression damage in the fibre direction is the best alternative. It has been shown that this established knowledge is not correct when the purpose is to produce at least the equivalent quality of printing and board paper grades with a reduced total energy consumption. The present method creates only a slight increase in energy consumption during chipping (verification experiment 3).

### BRIEF DESCRIPTION OF THE INVENTION CONCEPT

The main purpose of the present invention is to create a method for chipping that results in significantly reduced energy consumption during defibration and development of wood into single fibres in subsequent process steps. This occurs by an opening of the wood structure by the compressive loads that arise during chipping. This shall be achieved without any significant increase in energy consumption during chipping. An additional purpose of the present invention is to create a method for chipping that may be combined with at least one additional process step to reduce the energy consumption in at least one subsequent process step in the paper pulp production process. Another purpose of the present invention is to ease impregnation of the chips by chemicals or water and allow the impregnation chemicals to come into contact with a larger surface area upon which the chemicals can react. Another purpose of the present invention is to increase production capacity without new investments in the process steps after chipping.

### DETAILED DESCRIPTION OF THE INVENTION

The invention will be described in greater detail below with reference to the accompanying schematic drawings that in an exemplifying purpose show the current preferred embodiments of the invention.

FIG. 1 shows the angles of the chipping tool.

FIG. 2 shows schematically the process steps of wood chip production for pulping.

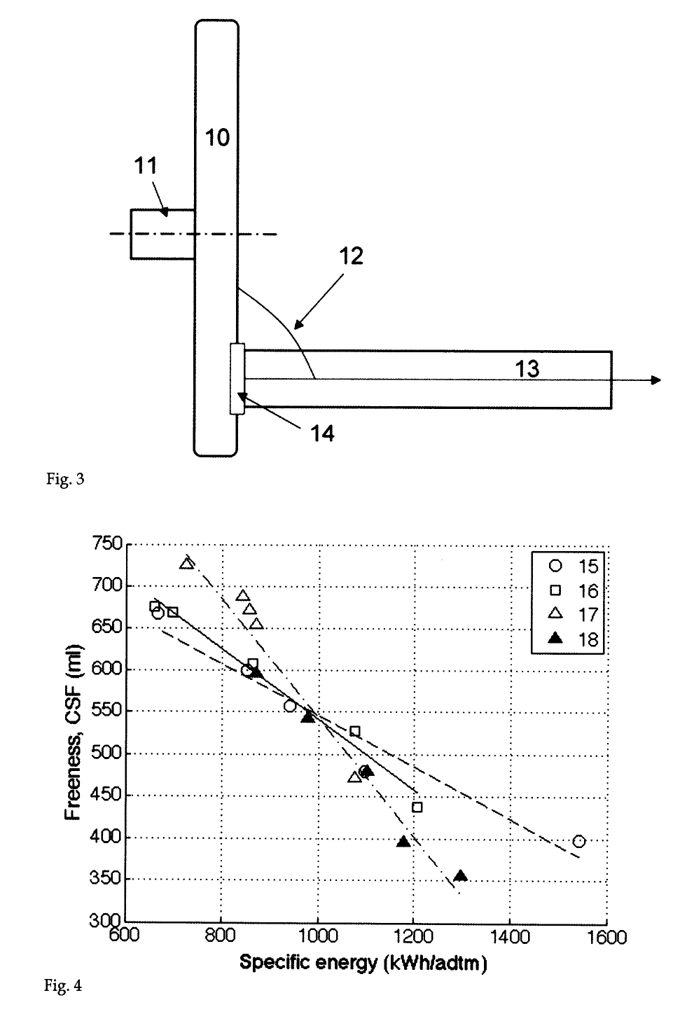

FIG. 3 defines e.g. the side angle 12.

FIG. 4 shows results from Verification Trial 1, TMP, freeness vs. specific energy consumption.

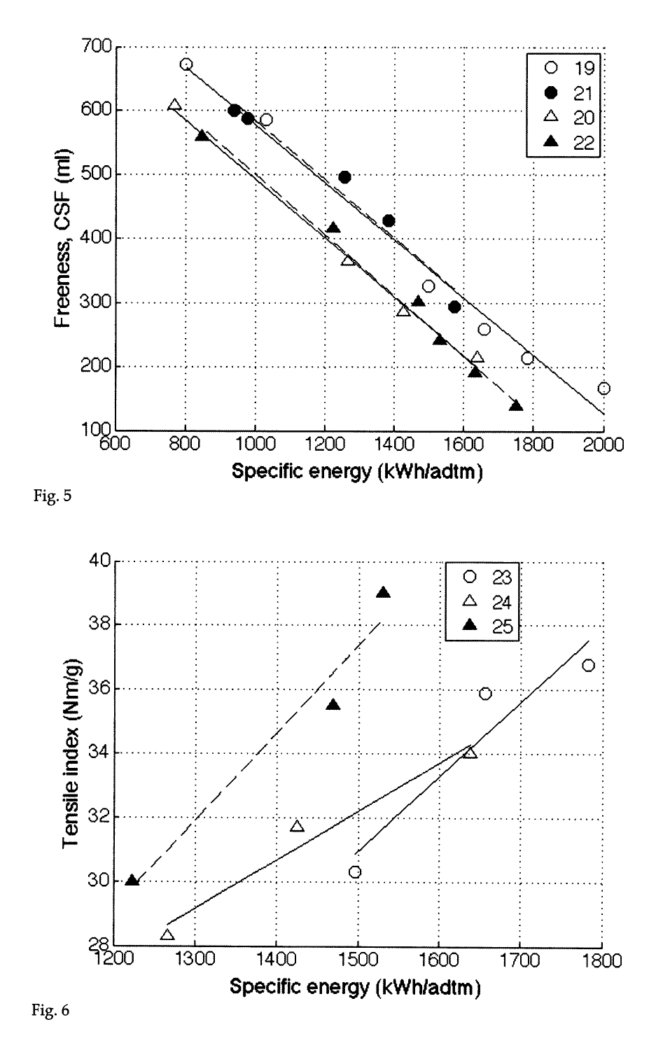

FIG. 5 shows results from Verification Trial 2, TMP and CTMP (printing paper quality), freeness vs. specific energy consumption.

FIG. 6 shows results from Verification Trial 2, TMP and CTMP (printing paper quality), tensile index vs. specific energy consumption.

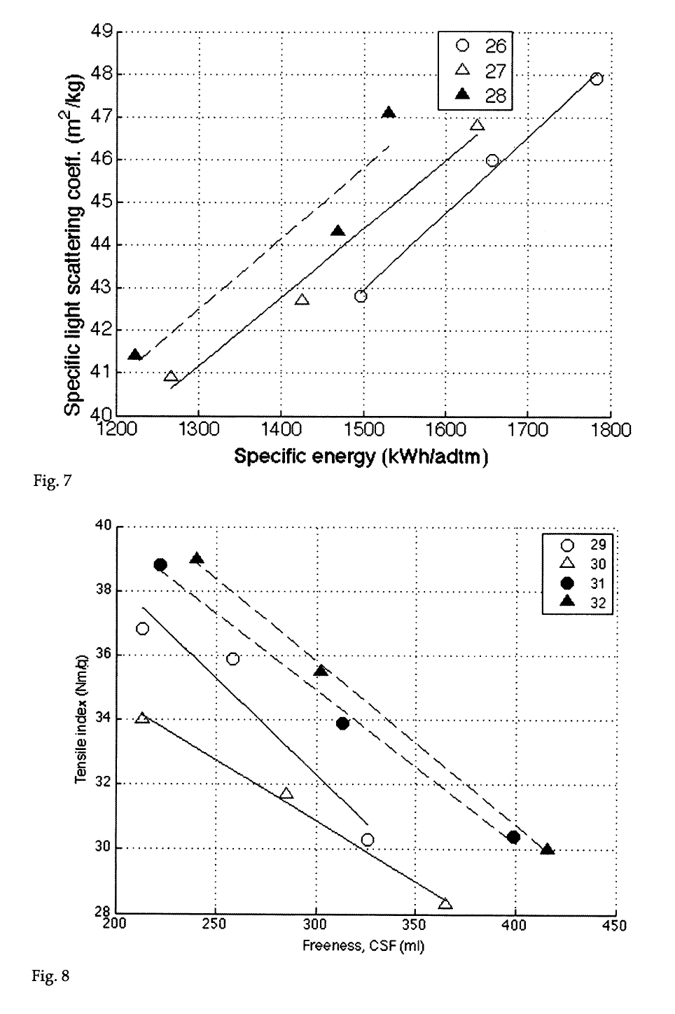

FIG. 7 shows results from Verification Trial 2, TMP and CTMP (printing paper quality), light scattering coefficient vs. specific energy consumption.

FIG. 8 shows results from Verification Trial 2, TMP and CTMP (printing paper quality), tensile index vs. freeness.

With reference to FIG. 2 a schematic method for the production and treatment of wood chips for wood pulp or similar products is shown. In the chipping stage 6, wood logs 1 or similar are chipped. The logs are preferably previously treated in a debarking stage 5 or similar. The chips may be treated in a step 7 by preheating, impregnation, steaming etc. before the chips are refined in a subsequent step 8. After a first refining stage, the defibrated chips are further refined in one or several stages 9 until the papermaking pulp or similar is finished. These stages all consists of previously known technology that are well known to professionals in the field of the present invention. The subsequent stages are outside of the definition of the present invention and are not described in any more detail in the present patent application.

The wood chipper utilized in the chipping process consists of a previously known type of wood chipper with one or several chipping tools 3, 14 in which chipping occurs according to the present chipping method. The present invention is applicable for chippers of the drum chipper, disc chipper as well as the reduction chipper types.

It has unexpectedly been shown that energy consumption in the subsequent refining stages is substantially reduced when wood chipping is performed with all of the chipper's chipping tools at the angle 4, in the range from 75° to 105° and preferably 80° to 100° between the wood fibre direction and the side of the chipping tool facing the chip.

Due to the wedge shape of the chipping tool loading angles in the range 75° to 105°, according to the present invention, will cause so large compressive forces in the fibre direction that a considerable cracking of the wood structure will happen. These compressive forces are directed in the fibre direction which is most beneficial. The process will in the following be called Directed Chipping, DC. The main requirement for this type of chipping is the application of loading angles 4 in the interval 75° to 105°. In currently utilized wood chippers, the loading angles are mostly around 115°.

In alternative embodiments of the present invention an adjustment of the chip length is done according to the wood raw material type and/or fibre length. The optimal chip length is different for different wood species. The adjustment of the chip length may occur within a considerable interval. For practical reasons such as the performance of subsequent feeding screws, the chip length should however remain in the interval 10-40 mm. It is however conceivable that other chip lengths than 10-40 mm may be used in alternative processes.

In an alternative embodiment of the present method the temperature of the wood logs is controlled in a pre-treatment stage 5 before chipping. The temperature of the wood logs is controlled to a desired temperature within the interval −10 to 130° C. The control of the log temperature may occur in a temperature controlled process zone or similar. The temperature may also be controlled in the choice of storage conditions for the logs. Storage may occur in water of different temperatures or alternatively in a conventional wood yard before debarking and chipping. Logs may for example be intermediately stored in hot process water after debarking which allows for high log temperatures before chipping. As the mechanical properties of wood depend strongly on the temperature, the degree of cracking of the chips during chipping will also depend on the temperature. In this alternative embodiment of the present method it is possible to choose a pre-treatment temperature so that optimal chip cracking occurs.

In an alternative embodiment of the present method the directional chipping is combined with a control of the solids content of the wood logs within the interval 30-70% solids content. This happens in a pre-treatment stage 5. The mechanical properties of wood are strongly influenced by the solids content and the loading angle's effect on chip cracking may be optimized by controlling the solids content. The solid content of wood may be adjusted and kept under control by a well organized logistics chain from logging through intermediate storage to the pulp mill wood yard, barking and chipping. The choice of storage conditions, e.g. in water, land storage with water irrigation or without irrigation will affect the solids content. This alternative embodiment of the present method optimizes the solids content so that an optimal chip cracking can occur.

In an alternative embodiment of the present method, the directional chipping in 6 is combined with a control of the cutting speed within the interval 15 to 40 m/s. Wood generally behaves as a visco-elastic material meaning that the cutting speed will have an influence on the cracking of the chips and that this speed may be optimized to achieve maximum cracking. Such speed control may be done by controlling the revolution speed of the motor of the chipper.

With reference to FIG. 3 where the direction of the log 13 relative to the cutting disc 10 and the load axel 11 is defined as the side angle 12, an alternative embodiment of the method is to use directed chipping in combination with controlling the side angles 12 within an interval between 0° to 45° relative to the fibre direction in the wood material. The stress conditions that are achieved by the load angle and which in turn influences chip cracking will also depend on the side angle. In this embodiment of the present invention, the stress state in the chip can be optimized to give maximum cracking of the chips. This control can be done through different geometric constructions of the log feeding system of the wood chipper.

In an alternative embodiment of the present method, the directional chipping in 6 is combined with chip impregnation with water, chemicals or enzymes in the next process step 7. The increased cracking of the wood that is achieved by using an adequate load angle will ease liquid diffusion into the chips and increase the specific surface area where liquids etc. may react in a beneficial manner with wood.

In mechanical pulping processes such as thermomechanical pulping or chemithermomechanical pulping, chemicals are often used to improve the fibre/pulp properties for specific end products (such as printing paper, board, tissue and fluff pulp). These chemicals can e.g. be added in the different process stages; chipping, chip impregnation, chip preheating 7 or during chip refining 8. For mechanical pulp production different types of sulphites, peroxides, caustic solutions (lye), complex binders and as of late also different types of enzymes are used to improve pulp properties. It has been shown that these types of chemicals together with the present invention significantly improve pulp characteristics compared to what can be achieved with conventional chipping technology.

For chemical pulping processes such as the sulphate (kraft) and sulphite processes both continuous and batch based cooking are used. Here the chemical impregnation is significantly improved by the present invention and the cooking (reaction) time is also significantly shortened. This will improve the production capacity in existing mills.

In the detailed description of the present invention design details and methods may have been omitted that are obvious to professionals in the field. Such obvious design details are included to the extent that is necessary so that the intended function of the present invention is achieved.

Even though certain preferred embodiments of the present invention have been described in detail, other variations and modifications within the scope of the invention may be realised by professionals in the field. All such variations and modifications are also considered to be within the scope of the following claims.

### Experimental Verification of the Invention

Results from experimental trials have shown that the present invention has unexpected technical effects. It has been verified that greater compression damage in chips has a beneficial effect on the pulping process. This new knowledge contradicts the well established knowledge in the industry that compression damage in chips should be avoided. In the following text, the results from three trials performed using the directional chipping of the present method are presented.

### Results (Verification Trial 1: Thermomechanical Pulp)

In the trial chips were produced using three different load angles 94°, 104° and 114° where 114° corresponds to conventional technology, see angle γ in FIG. 1. The three produced chip qualities were then refined separately in a first stage pilot refiner. The dewatering parameter, Canadian Standard Freeness, CSF was measured for pulps produced at different specific energy consumptions. The average chip length was 25 mm and the cutting speed was 20 m/s. FIG. 4 shows CSF (ml) plotted against the specific energy consumption (kWh/t). High CSF values correspond to a low degree of fibre development whereas low CSF values correspond to a high degree of fibre development. Position 15 and 16 show the results for the load angles 114° and 104° respectively. Position 17 and 18 show the results for the load angle 94° at a high respective a low production rate. If the curve for 114° is extrapolated to CSF 350 ml, we get a specific energy consumption of 1700 kWh/t. At 94° CSF 350 ml corresponds to 1300 kWh/t corresponding to a reduction in specific energy consumption of 20-25%. In this context this is a very significant energy reduction which was completely unexpected.

### Results (Verification Trial 2: Chemi-Thermomechanical Pulp)

In the second trial the effect of the load angle on production of thermomechanical and two different chemi-thermomechanical pulps was investigated. The chipping was done as in trial 1 but only with the load angles 94° and 114°. The pulp refining in this trial was performed in two stages unlike trial 1.

In FIG. 5 the CSF values (ml) are given on the vertical axis and the specific energy consumption (kWh/t) is given on the horizontal axis. Position 20 and 22 in FIG. 5 shows results for chips produced with a load angle of 94° where the chemical NaHS0₃ has been added to the dilution water in the refiner for position 22 whereas position 20 is TMP. Similarly position 19 and 21 shows the results for chips produced with a load angle of 114° (conventional) without and with addition of NaHSO₃ in the dilution water respectively. Also in this case it is clearly evident that the chips produced at the load angle 94° give less specific energy consumption than chips produced at 114° compared at the same CSF.

An important property, particularly for printing paper, is the tensile strength, here given as the tensile strength index. In FIG. 6, position 23 shows the tensile index for paper as a function of the specific energy consumption during TMP production from chips cut with a load angle of 114° and in position 24 the same is shown for the load angle 94°. Position 25 shows the results for paper produced from pulp where a load angle of 94° was used and NaHSO₃ were added to the dilution water in the refiner.

Another important property of printing paper is its opacity which depends on the light scattering properties of the paper. FIG. 7 shows the specific light scattering coefficient as a function of the specific energy consumption in the same manner as above. Positions 26, 27 and 28 correspond to the positions 23, 24 and 25 with regards to the load angle etc.

During paper production it is beneficial if the pulp's dewatering properties (CSF) can be controlled so that the predetermined end use properties in the paper such as tensile strength and opacity are as optimal as possible. The dependency of tensile stiffness index on the dewatering property CSF is shown in FIG. 8 where position 29 and 30 is TMP from chips produced at 114° and 94° respectively and position 31 and 32 is pulp from chips produced at 114° and 94° respectively where NaHSO₃ were added to the dilution water in the refiner.

The pulp that was produced from chips chipped using a load angle of 94° and with NaHSO₃ in the dilution water had the best combination of properties for printing paper and in addition the lowest specific energy consumption.

When chemithermomechanical (CTMP) pulps are produced for board, tissue and fluff pulp qualities, high bulk (low density) and absorption properties are important, however opacity is not important. These types of CTMP are produced by impregnating the chips with an alkaline sulphite solution (Na₂SO₃) in an impregnation vessel after which the chips are pre-heated so that the sulphite has time to react with the wood before the chips reach the refiner. The fibres ability to give a high bulk depends on how large a fraction of intact fibres that have been produced in the refiner. This is limited by the demand for very low shives content in the pulp. It has been shown that CTMP produced from chips chipped at a load angle of 94° has a considerably lower specific energy consumption to reach a certain low shive level compared to CTMP produced at a load angle of 114°.

In summary it can be concluded (among other things) that (FIGS. 6 and 7) it is possible to produce thermomechanical and chemithermomechanical pulp for printing paper at a reduced specific energy consumption to the same tensile index and light scattering coefficient by producing paper from pulp which is refined from chips produced using the load angle 94°. Further it has been shown that it is possible to produce chemithermomechanical pulp for board, tissue and fluff pulp with a reduced specific energy consumption to a certain low shives content when the pulp is refined from chips produced with the 94° load angle.

### Results (Verification Trial 3: The Influence of the Load Angle on the Total Energy Consumption During Pulp Production)

If the energy that is saved in a later stage in the refining process is larger than the increase in energy consumption during chipping with the load angle at 94° (compared to 114°), the proposed method according to the present invention is highly valuable. To investigate the energy consumption during chipping for the load angles 114° and 94° the trials described below were conducted.

At the load angle 114° and a chip length of 25 mm the chipper was adjusted to a speed of 400 rpm which corresponds to a speed of 20 m/s for the chipping tool. When this speed was reached, the energy supply was turned off for the electric engine driving the chipper. Then the number of chips lengths produced by the stored rotational energy in the system was measured. This was done so that the length of the wood log with cross sectional dimensions of 50 mm×100 mm, that was chipped before the chipper stopped completely was measured and divided by the chip length of 25 mm. For the load angle 114° the number of chip lengths was 134 and for 94° the number of chip lengths was 120. The moment of inertia of the rotating system is 142 kgm² so the stored rotational energy could be calculated to 1.25*10⁵ J shortly before the chipping started. The energy consumption per chip length for the two load angles is then respectively 0.90 kJ for 114° and 0.94 for 94°. Assuming a density of 350 kg/m³ for dry Norway spruce and that each chip length produced a volume of 0.025×0.05×0.1 m³=1.24*10⁻⁴ m³ and thus the weight 0.043 kg this meaning that 5.8 kWh is consumed to produce one metric ton of chips at the load angle 114° while 6 kWh are consumed at a 94° load angle. This must be compared to a total energy consumption of 1500-2000 kWh/t pulp.

### Advantages of the Invention

By use of a chipping method according to the present invention a number of benefits are achieved. The most prominent benefit is the increased energy efficient refining of the chips when they are produced in accordance with the method of the present invention. This is achieved thanks to that the chipping method according to the present patent application causes a beneficial cracking between the fibres in the chips so that they are more easily separated.

The more open structure of the chips also provides the benefit that chemicals such as sulphite solutions, peroxide solutions, alkali and others in addition to enzymes get better access to a larger reaction surface. This increases reaction speed, improves reaction evenness and reduces the chemical consumption to reach a certain pulp property. The chip refining is made more efficient by the more even impregnation of the chips and thus less problems occur with parts of the chips not being treated by the chemicals. An ineffective reaction between chips and chemicals cause more formation of shives during refining and in addition the added chemicals are less efficiently used which is a major problem in pulping.

1. A method for producing and treating wood chips with the intention of decreasing the specific energy consumption in subsequent pulp production process stages, wherein the chipping process is performed by a chipper having its chipping tools at the angle γ between the fibre orientation and the side of the chipping tool facing the chip within an interval from 75 to 105° which will cause an axial compression of the chips which in turn causes cracking of the chips during chipping.

2. The method for wood chipping according to claim 1, wherein the angle γ is within the interval 85° to 100°.

3. The method for wood chipping according to claim 1, wherein the chips are chipped at lengths in the range between 10 and 40 mm.

4. The method for wood chipping according to claim 1, wherein the method includes a pre-treatment stage where the temperature of the log is controlled within the range −10 to 130° C.

5. The method for wood chipping according to claim 1, wherein the method is combined with a pre-treatment stage where the solids content of the log is controlled within the interval 30% to 70% solids content.

6. The method for wood chipping according to claim 1, wherein the method includes the control of the speed of the chipping tool within the interval 15 m/s to 40 m/s.

7. The method for wood chipping according to claim 1, wherein the chipping is performed using side angles in the interval 0° to 45° relative to the fibre direction of the log.

8. The method for wood chipping according to claim 1, wherein the method is combined with water, chemicals, or enzyme impregnation.

9. The method for wood chipping according to claim 1, wherein the method is combined with pre-treatment of the chips in a compression screw.

10. The method for wood chipping according to claim 1, wherein the method is combined with the addition of water in at least one of the process stages, chip pre-steaming, chip impregnation, chip pre-heating or chip refining.

11. The method for wood chipping according to claim 1, wherein the method is combined with the addition of chemicals in at least one of the process stages, chip pre-steaming, chip impregnation, chip pre-heating or chip refining.

12. The method for wood chipping according to claim 1, wherein the method is combined with the addition of enzymes in at least one of the process stages, chip pre-steaming, chip impregnation, chip pre-heating or chip refining.

13. The method for wood chipping according to claim 1, wherein the method is combined with continuous cooking of chemical pulp.

14. The method for wood chipping according to claim 1, wherein the method is combined with batch cooking of chemical pulp.
